(19) United States
(12) Patent Application Publication
(10) Pub. No.: US 2026/0074234 A1
(43) Pub. Date: Mar. 12, 2026

(54) COMPOSITE SUBSTRATE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Junyoung KIM, Yongin-si (KR); Wonhyung LEE, Yongin-si (KR); Suhyun KIM, Yongin-si (KR); Jungwook CHA, Yongin-si (KR); KyuSeo LEE, Yongin-si (KR); Yeonhee YOON, Yongin-si (KR); Dayoung KANG, Yongin-si (KR); Minseok KWON, Yongin-si (KR); Seokho WOO, Yongin-si (KR)

(73) Assignee: SAMSUNG SDI CO., LTD., Yongin-si, Gyeonggi-do (KR)

(21) Appl. No.: 19/287,152

(22) Filed: Jul. 31, 2025

(30) Foreign Application Priority Data
Sep. 12, 2024 (KR) 10-2024-0124611

(51) Int. Cl. H01M 4/66; H01M 10/052

(52) U.S. Cl. CPC H01M 4/667; H01M 4/661; H01M 4/668; H01M 10/052

(57) ABSTRACT

Examples of the disclosure include a composite substrate for a rechargeable lithium battery that includes a support layer including a polymer film, and a metal layer disposed on the support layer and including at least one of copper and copper oxide. The metal layer includes a first metal layer on a surface of the support layer and including an adhesion enhancer and a first copper, and a second metal layer on the first metal layer and including a second copper. The adhesion enhancer includes a first moiety chemically bonded to the surface of the support layer and including a hydroxyalkylene group, and a second moiety including an amine group configured to adsorb the first copper.

### CROSS-REFERENCE TO RELATED APPLICATIONS

This U.S. non-provisional patent application claims priority under 35 U.S.C. § 119 of Korean Patent Application No. 10-2024-0124611, filed on Sep. 12, 2024, the entire contents of which are hereby incorporated by reference.

### BACKGROUND

The present disclosure herein relates to a composite substrate for a rechargeable lithium battery, and a rechargeable lithium battery including the composite substrate.

With increased use of battery-powered electronics, such as, e.g., mobile phones, laptop computers, electric vehicles, and the like, has driven a sharp rise in demand for rechargeable batteries having high energy density and high capacity. Accordingly, improving the performance of rechargeable lithium batteries may be advantageous.

Rechargeable lithium batteries include a positive electrode and a negative electrode, each including an active material that allows intercalation and deintercalation of lithium ions, and an electrolyte solution, and produce electrical energy from redox reactions that take place as lithium ions are intercalated into or deintercalated from the positive electrode and the negative electrode.

### SUMMARY

Examples of the present disclosure include a composite substrate for a rechargeable lithium battery exhibiting improved adhesive strength between a metal layer and a support layer including a polymer film.

Examples of the present disclosure also include a rechargeable lithium battery exhibiting desired or improved stability, including the composite substrate.

An example embodiment of the present invention includes a composite substrate for a rechargeable lithium battery that includes a support layer including a polymer film, and a metal layer on the support layer and including at least one of copper, copper oxide, or a combination thereof. The metal layer includes a first metal layer on a surface of the support layer and including an adhesion enhancer and a first copper, and a second metal layer on the first metal layer and including a second copper. The adhesion enhancer includes a first moiety chemically bonded to the surface of the support layer and including a hydroxyalkylene group, and a second moiety including an amine group configured to adsorb the first copper.

In an example embodiment of the present invention, a method for preparing a composite substrate for a rechargeable lithium battery includes modifying a surface of a support layer, forming a first metal layer including a first copper on the modified surface of the support layer, and forming a second metal layer including a second copper on the first metal layer. The forming of the first metal layer includes bonding a first compound including a glycidyl group to the modified surface of the support layer, bonding a second compound including an amine group to an end of the first compound to form an adhesion enhancer, impregnating the support layer with a first solution including first copper ions, and impregnating the support layer with a second solution including a reducing agent to reduce the first copper ions.

In an example embodiment of the present invention, a rechargeable lithium battery includes the composite substrate for a rechargeable lithium battery, and a battery cell on the composite substrate, wherein the battery cell includes a first active material layer on the metal layer, a separator on the first active material layer, a second active material layer on the separator, and a metal substrate on the second active material layer.

### BRIEF DESCRIPTION OF THE FIGURES

The accompanying drawings are included to provide a further understanding of the present invention, and are incorporated in and constitute a part of this specification. The drawings illustrate embodiments of the present invention and, together with the description, be configured to explain principles of the present invention. In the drawings:

FIG. 1 is a simplified conceptual view illustrating a rechargeable lithium battery according to example embodiments of the present invention;

FIGS. 2 through 5 are schematic views each illustrating a rechargeable lithium battery according to an example embodiment;

FIG. 6 is a cross-sectional view illustrating a rechargeable lithium battery including a composite substrate according to example embodiments of the present invention;

FIG. 7 is a cross-sectional view illustrating the composite substrate of FIG. 6;

FIG. 8 is a view enlarging M of FIG. 7;

FIG. 9 is a cross-sectional view illustrating modifying a surface of a support layer according to example embodiments of the present invention;

FIG. 10 is a view enlarging N of FIG. 9;

FIG. 11 is a conceptual view illustrating that a first compound is bonded to a surface of a support layer according to example embodiments of the present invention;

FIG. 12 is a conceptual view illustrating that an adhesion enhancer is bonded to a surface of a support layer according to example embodiments of the present invention;

FIG. 13 is a conceptual view illustrating a process of forming a first metal layer and a second metal layer according to example embodiments of the present invention;

FIG. 14 is a view enlarging O of FIG. 13;

FIG. 15 is a conceptual view illustrating an interaction between an adhesion enhancer and copper ions according to example embodiments of the present invention;

FIG. 16 is a view enlarging P of FIG. 13; and

FIG. 17 is a view enlarging Q of FIG. 13.

FIG. 18 is a flow chart illustrating a method for preparing a composite substrate for a rechargeable lithium battery, according to an example embodiment.

### DETAILED DESCRIPTION

In order to sufficiently understand the configuration and effects of the present invention, example embodiments of the present invention are described with reference to the accompanying drawings. It should be noted, however, that the present invention is not limited to the following example embodiments, and may be implemented in various forms and variously modified. The example embodiments herein are provided so that the present invention is thorough and complete and fully conveys the scope of the present invention to those skilled in the art.

Herein, it is understood that when a component is referred to as being “on” another component, the component may be “directly on” another component, or an intervening third component may be present. In addition, in the drawings, thicknesses of components may be exaggerated for effectively describing technical contents. Like reference numerals refer to like elements throughout.

Unless otherwise specified herein, the expression of singular form may include the expression of plural form. In addition, unless otherwise specified, the phrase “A or B” may indicate “A but not B,” “B but not A,” or “A and B.” The terms “comprises” and/or “comprising” used herein do not exclude the presence or addition of one or more other components.

As used herein, the term “combination thereof” may refer to a mixture, a stack, a composite, a copolymer, an alloy, a blend, or a reaction product.

Unless otherwise defined herein, a particle diameter may be an average particle diameter. In addition, a particle diameter is defined as an average particle diameter (D50) indicating the diameter of particles at a cumulative volume of about 50 vol % in particle size distribution. The average particle diameter (D50) may be measured by a method widely known to those skilled in the art, for example, by a particle size analyzer, an image of transmission electron microscope (TEM), or an image of scanning electron microscope (SEM). Alternatively, the average particle diameter (D50) may be measured by a measurement device using dynamic light-scattering, wherein data analysis is conducted to count the number of particles for each particle size range, and an average particle diameter (D50) value may then be obtained through calculation. Also, a laser scattering method may be utilized to measure the average particle diameter. In the measuring using the laser diffraction method, for example, target particles are dispersed in a dispersion medium, then introduced into a commercially available laser diffraction particle diameter measuring device (e.g., MT 3000 available from Microtrac, Ltd.), and irradiated with ultrasonic waves of about 28 kHz at a power of about 60 W, and then an average particle diameter (D50) based on about 50% of the particle diameter distribution in the measuring device may be calculated.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

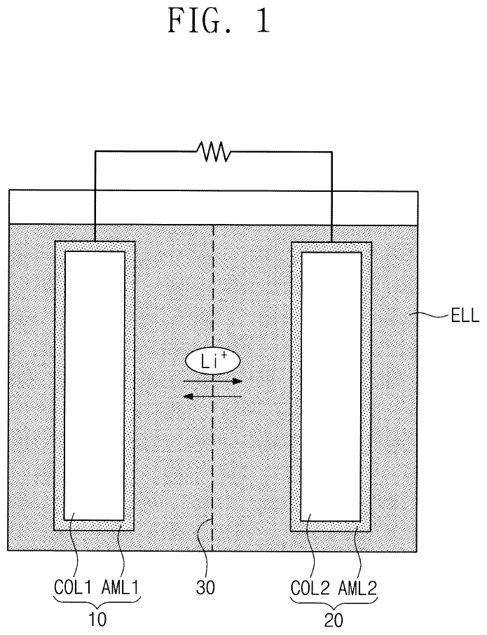

FIG. 1 is a simplified conceptual view showing a rechargeable lithium battery according to example embodiments of the present invention. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be disposed between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be impregnated in the electrolyte solution ELL.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and may further include a binder and/or a conductive material.

For example, the positive electrode 10 may further include an additive configured as a sacrificial positive electrode.

The positive electrode active material layer AML1 may include about 90 wt % to about 99.5 wt % of the positive electrode active material with respect to 100 wt % of the positive electrode active material layer AML1. With respect to 100 wt % of the positive electrode active material layer AML1, the binder and the conductive material may amount to a range of about 0.5 wt % to about 5 wt %.

The binder may be configured to attach positive electrode active material particles to one another, and to attach the positive electrode active material to the current collector COL1. Typical examples of the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but the embodiment of the present invention is not limited thereto.

The conductive material may be included to impart conductivity to the electrode. Any material that does not cause chemical changes and is an electron conductive material may be usable in batteries. Examples of the conductive material may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like in the form of a metal powder or a metal fiber; a conductive polymer such as a polyphenylene derivative; or a mixture thereof.

Al may be included as the current collector COL1, but the example embodiment of the present invention is not limited thereto.

### Positive Electrode Active Material

A compound capable of reversibly intercalating and deintercalating lithium (lithiated intercalation compound) may be included as a positive electrode active material in a positive electrode active material layer AML1. For example, at least one of a complex oxide of lithium and a metal such as or including at least one of cobalt, manganese, nickel, and a combination thereof may be included.

The complex oxide may be or include a lithium transition metal complex oxide, and examples thereof include at least one of lithium nickel-based oxide, lithium cobalt-based oxide, lithium manganese-based oxide, lithium iron phosphate-based compound, cobalt-free nickel-manganese-based oxide, or a combination thereof.

For example, a compound represented by any one of the following Formulas may be included. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In Formulas above, A is or includes at least one of Ni, Co, Mn, or a combination thereof, X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high nickel-based positive electrode active material having a nickel content of about 80 mol % or greater, about 85 mol % or greater, about 90 mol % or greater, about 91 mol % or greater, or about 94 mol % or greater, with respect to 100 mol % of metals excluding lithium from the lithium transition metal complex oxide. The high nickel-based positive electrode active material may achieve high capacity, and may thus be applicable to high-capacity, high-density rechargeable lithium batteries.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material.

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may be configured to attach the negative electrode active material particles to each other, and to attach the negative electrode active material to the current collector COL2. The binder may include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinyl pyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be included to impart conductivity to the electrode. Any material that does not cause chemical changes and is an electron conductive material may be usable in batteries. Examples of the conductive material may include a carbon-based material such as at least one of natural graphite, artificial graphite, carbon black, acetylene black, Ketjen black, a carbon fiber, a carbon nanofiber, and carbon nanotube; a metal-based material including at least one of copper, nickel, aluminum, silver, and the like, in the form of a metal powder or a metal fiber; a conductive polymer such as a polyphenylene derivative; or a mixture thereof.

The current collector COL2 may be or include at least one of a copper foil, a nickel foil, a stainless steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that reversibly intercalates/deintercalates lithium ions, a lithium metal, a lithium metal alloy, a material capable of doping/de-doping lithium, or a transition metal oxide.

The material that reversibly intercalates/deintercalates lithium ions may include a carbon-based negative electrode active material, for example, crystalline carbon, amorphous carbon, or a combination thereof. Examples of the crystalline carbon may be or include at least one of graphite such as irregular, planar, flaky, spherical, or fibrous natural graphite or artificial graphite, and examples of the amorphous carbon may be or include at least one of soft carbon, hard carbon, mesophase pitch carbide, fired cokes, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or an Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline earth metal, a Group 13 element, a Group 14 element (except for Si), a Group 15 element, a Group 16 element, a transition metal, a rare-earth element, and a combination thereof), or a combination thereof. The Sn-based negative electrode active material may be or include at least one of Sn, SnO₂, an Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core), in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be included in combination with a carbon-based negative electrode active material.

### Separator 30

Depending on the type of the rechargeable lithium battery, the separator 30 may be present between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one surface, or on both surfaces, of the porous substrate.

The porous substrate may be or include a polymer film formed of or including a polymer such as at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Electrolyte Solution ELL

The electrolyte solution ELL for a rechargeable lithium battery may include a non-aqueous organic solvent and a lithium salt.

The non-aqueous organic solvent may be configured as a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like, and the aprotic solvent may include at least one of nitriles such as R—CN (where R is a C2 to C20 linear, branched, or cyclic hydrocarbon group and may include a double bond, an aromatic ring, or an ether group); amides such as dimethylformamide; dioxolanes such as 1,3-dioxolane, 1,4-dioxolane; sulfolanes, and the like.

The non-aqueous organic solvents may be included alone or in combination of two or more solvents.

In addition, when using a carbonate-based solvent, a cyclic carbonate and a chain carbonate may be mixed and included, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Typical examples of the lithium salt may include at least one of LiPF₆, LiBF₄, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

### Rechargeable Lithium Battery

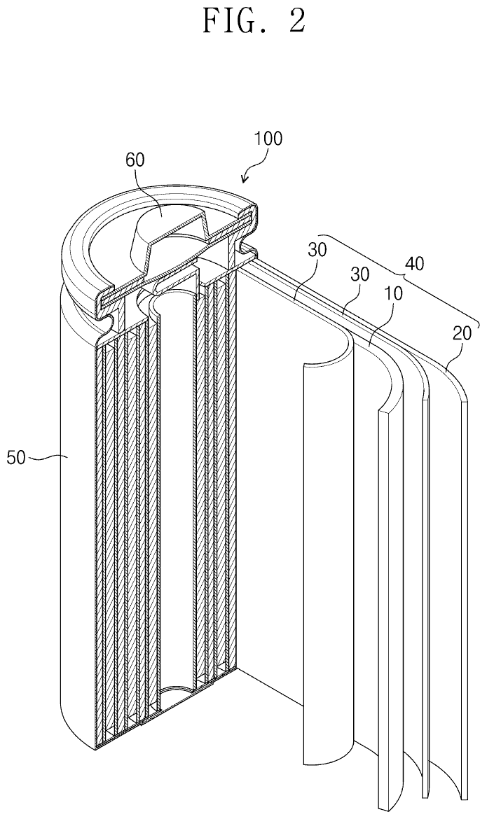

The rechargeable lithium battery may be classified into cylindrical, prismatic, pouch, or coin-type batteries, and the like depending on their shape. FIGS. 2 to 5 are schematic views illustrating a rechargeable lithium battery according to an example embodiment, and FIG. 2 shows a cylindrical battery, FIG. 3 shows a prismatic battery, and FIGS. 4 and 5 show pouch-type batteries. Referring to FIGS. 2 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electrical path for inducing the current formed in the electrode assembly 40 to the outside of the battery 100.

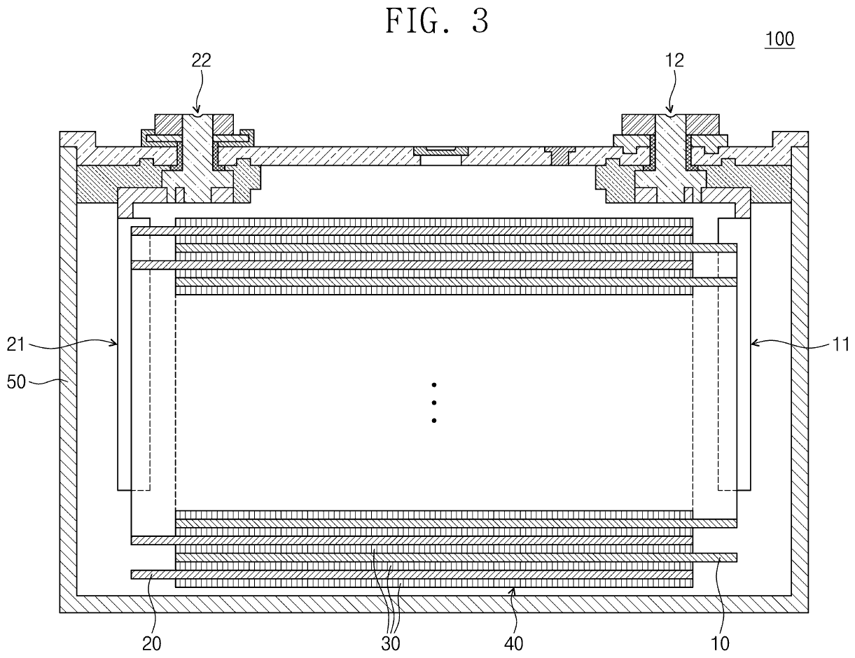

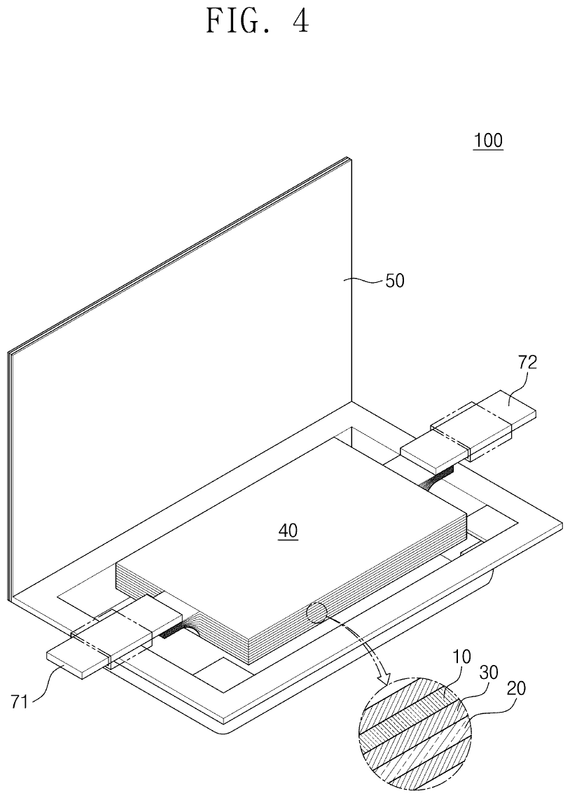

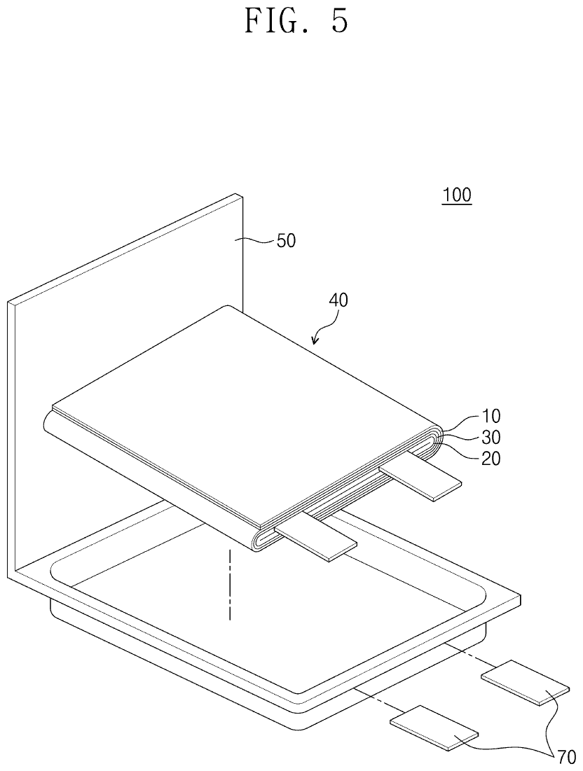

FIG. 6 is a cross-sectional view illustrating a rechargeable lithium battery including a composite substrate according to example embodiments of the present invention. FIG. 7 is a cross-sectional view illustrating the composite material of FIG. 6. FIG. 8 is a view enlarging M of FIG. 6. To simplify descriptions, any description overlapping with the description of the rechargeable lithium battery provided above with reference to FIGS. 1 to 5 is not provided again.

Referring to FIG. 6, a composite substrate CPS, a first battery cell CEL1 on one surface of the composite substrate CPS, and a second battery cell CEL2 on the other surface of the composite substrate CPS are illustrated. The first battery cell CEL1, the second battery cell CEL2, and the composite substrate CPS in FIG. 6 may constitute one bicell. The first battery cell CEL1, the second battery cell CEL2, and the composite substrate CPS in FIG. 6 may constitute the electrode assembly 40 described above with reference to FIGS. 2 to 5.

The first battery cell CEL1 and the second battery cell CEL2 may each include a first active material layer ACT1, a separator 30, a second active material layer ACT2, and a metal substrate MES. The second active material layer ACT2 may be provided on the composite substrate CPS. The first active material layer ACT1 may be spaced apart from the second active material layer ACT2 with the separator 30 therebetween. The metal substrate MES may be provided on the first active material layer ACT1.

The first active material layer ACT1 may be either one of the positive electrode active material layer AML1 and the negative electrode active material layer AML2 described above with reference to FIG. 1. The second active material layer ACT2 may be the other one of the positive electrode active material layer AML1 and the negative electrode active material layer AML2 described above with reference to FIG. 1. In an example embodiment of the present invention, the first active material layer ACT1 may be the positive electrode active material layer AML1, and the second active material layer ACT2 may be the negative active material layer AML2. The metal substrate MES may be the current collector COL1 or COL2 described above with reference to FIG. 1.

The composite substrate CPS may include a support layer SPL, and a third metal layer MEL3 and a fourth metal layer MEL4 each provided on a side of the support layer SPL. The support layer SPL may constitute about 20 wt % to about 30 wt % of the composite substrate CPS.

The third metal layer MEL3 of the composite substrate CPS may be in contact with the second active material layer ACT2 of the first battery cell CEL1. The fourth metal layer MEL4 of the composite substrate CPS may be in contact with the second active material layer ACT2 of the second battery cell CEL2. The third metal layer MEL3 and the fourth metal layer MEL4 of the composite substrate CPS may correspond to the current collector COL1 or COL2 described above with reference to FIG. 1.

The support layer SPL may include a polymer film. For example, the support layer SPL may have a thickness in a range of about 2 μm to about 10 μm. For example, the support layer SPL may include at least one of a polyethylene film, a polypropylene film, a polyvinylidene chloride film, or a multilayer film including a combination thereof. The support layer SPL may have a desired or improved ion permeability and a desired or improved mechanical strength.

The third metal layer MEL3 and the fourth metal layer MEL4 may each include at least one of aluminum, aluminum alloy, copper, copper alloy, nickel, nickel alloy, titanium, titanium alloy, iron, iron alloy, silver, or silver alloy.

In an example embodiment of the present invention, the third metal layer MEL3 and the fourth metal layer MEL4 may each have a thickness in a range of about 0 μm to about 5 μm. For example, the third metal layer MEL3 and the fourth metal layer MEL4 may each have a thickness in a range of about 200 nm to about 5 μm. The support layer SPL may have a thickness in a range of about 2 μm to about 10 μm. The thickness of the support layer SPL may be greater than the thicknesses of each of the third layer MEL3 and the fourth metal layer MELA.

The composite substrate CPS may include a first end ENP1 at one end thereof. The metal substrate MES of the first battery cell CEL1 may include a second end ENP2 at one end thereof. The metal substrate MES of the second battery cell CEL2 may include a third end ENP3 at one end thereof.

A first tab TAB1 may be provided at the first end ENP1 of the composite substrate CPS. The first tab TAB1 may include a first connection portion UPP1, a second connection portion UPP2, and an extension portion EXP. The first connection portion UPP1 may be in contact with the third metal layer MEL3 of the composite substrate CPS. The second connection portion UPP2 may be in contact with the fourth metal layer MELA of the composite substrate CPS. The extension portion EXP may connect the first connection portion UPP1 and the second connection portion UPP2 together. The extension portion EXP may extend substantially horizontally from the first end ENP1 toward the first direction D1.

The third metal layer MEL3 and the fourth metal layer MEL4 may be electrically connected through the first tab TAB1. The first tab TAB1 may be configured to transmit or apply a common voltage to the third metal layer MEL3 and the fourth metal layer MELA.

A second tab TAB2 may be provided at the second end ENP2 of the metal substrate MES. The second tab TAB2 may be configured to transmit or apply voltage to the metal substrate MES of the first battery cell CEL1. A third tab TAB3 may be provided at the third end ENP3 of the metal substrate MES. The third tab TAB3 may be configured to transmit or apply voltage to the metal substrate MES of the second battery cell CEL2.

The first tab TAB1 may constitute any one of the positive electrode tab (or positive electrode lead tab) and the negative electrode tab (or negative electrode lead tab) described above with reference to FIGS. 2 to 4. The second tab TAB2 and the third tab TAB3 may constitute the other one of the positive electrode tab (or positive electrode lead tab) and the negative electrode tab (or negative electrode lead tab) described above with reference to FIGS. 2 to 4.

Referring to FIGS. 7 and 8, the support layer SPL may include a plurality of bonding portions BA. The plurality of bonding portions BA may each have an irregular shape, and may have a three-dimensional structure. For example, the plurality of bonding portions BA may each include a protruding form in a direction substantially perpendicular to a surface PW_U of the support layer SPL (e.g., a third direction D3) and/or in a direction parallel to a surface of the support layer SPL (e.g., a first direction D1 or a second direction D2). The plurality of bonding portions BA may each be spaced apart along the first direction D1 and/or the second direction D2.

The third and fourth metal layers MEL3 and MELA may be disposed on both surfaces of the support layer SPL. Each of the third and fourth metal layers MEL3 and MELA may include a first metal layer MEL1, and a second metal layer MEL2 on the first metal layer MEL1.

The first metal layer MEL1 may be disposed on a surface of the support layer SPL and may include an adhesion enhancer and a first copper. The first metal layer MEL1 may have a thickness in a range of about 2 nm to about 5 nm. The adhesion enhancer may be chemically bonded to the surface of the support layer SPL, and may be chemically bonded to the plurality of bonding portions BA.

The adhesion enhancer may include a first moiety chemically bonded to the surface of the support layer SPL and including a hydroxyalkylene group, and a second moiety including an amine group configured to adsorb the first copper. The hydroxyalkylene group may indicate a structure in which a hydroxy functional group (—OH) is bonded to an alkylene chain (CₙH₂ₙ). The amine group may indicate a group including an amine functional group. For example, the amine group may indicate an alkyl group (CₙH₂ₙ₊₁) or an alkylene group (CₙH₂ₙ) including an amine functional group (e.g., —NH— or —NH2).

The adhesion enhancer may include a compound of Formula 1 below.

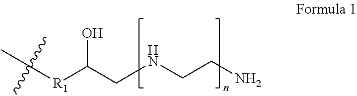

The radical “R1” is or includes any one of C₁ to C₁₀ alkylene groups, and “n” may be in a range of about 1 to about 10. A wavy line shown in Formula 1 may indicate a portion chemically bonded to a functional group on the surface of the support layer SPL, or a polymer on the surface of the support layer SPL. For example, the wavy line may indicate a portion chemically bonded to a functional group including oxygen on the surface of the plurality of bonding portions BA (e.g., —O²⁻, —COOH, or —OH).

The first moiety may include Formula 2 below.

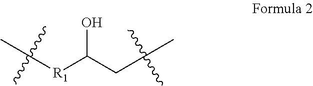

As described above, the wavy line adjacent to R1 may indicate a portion chemically bonded to a functional group on the surface of the support layer SPL, or an attached polymer on the surface of the support layer SPL. The other wavy line may indicate a portion chemically bonded to a second moiety.

The second moiety may include Formula 3 below.

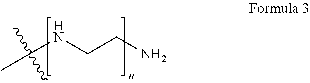

A wavy line shown in Formula 3 may indicate a portion chemically connected to the first moiety. Amine groups of the second moiety may stabilize copper ions. For example, the copper ions may be stabilized by amine groups having a free electron pair that may be bonded to the copper ions. For example, the copper ions may be stabilized by chelate formation through coordination bonding with amine groups. The second moiety may allow first copper ions, as described below, to be adsorbed onto an adhesion enhancer.

The second metal layer MEL2 may include a second copper. The second metal layer MEL2 may have a greater thickness than the first metal layer MEL1. The second metal layer MEL2 may have a thickness in a range of about 150 nm to about 3 μm. A bonding strength between the support layer SPL and the third metal layer MEL3 (or the fourth metal layer MEL4) may be in a range of about 700 N/m to about 1200 N/m.

According to example embodiments of the present invention, the first metal layer MEL1 may include an adhesion enhancer. The adhesion enhancer may include a first moiety including a hydroxyalkylene group, and a second moiety including an amine group configured to adsorb a first copper. Copper ions may be stably adsorbed onto the adhesion enhancer through the second moiety. The support layer SPL and the metal layers MEL3 and MEL4 may provide a desired or improved adhesive strength through the first moiety and the second moiety.

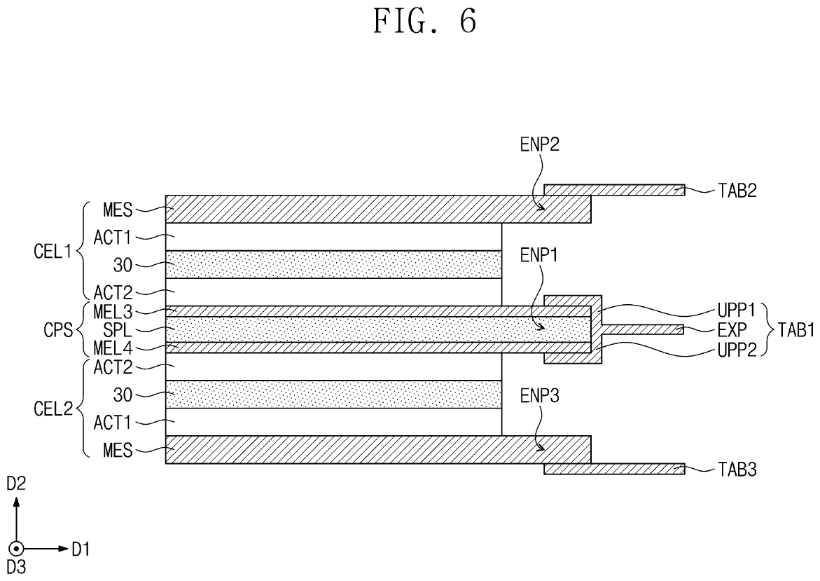

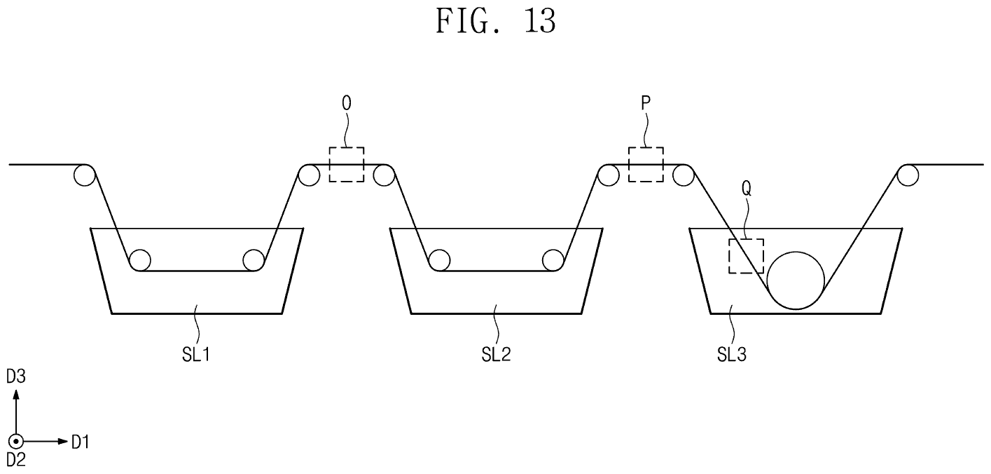

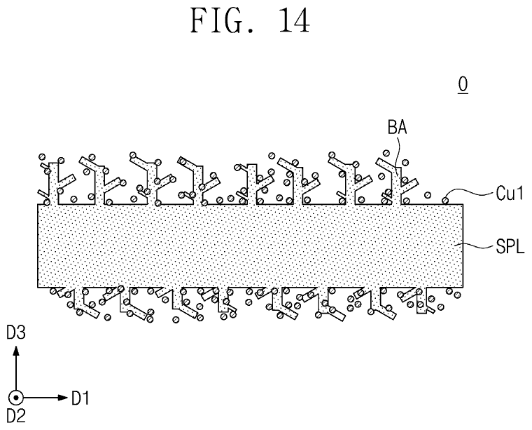

FIGS. 9 through 17 are cross-sectional views illustrating a method for preparing a composite material for a rechargeable lithium battery according to example embodiments of the present invention. To simplify descriptions, any description overlapping with the description of the rechargeable lithium battery described above with reference to FIGS. 1 to 9 is not redundantly provided.

Referring to FIG. 9, a support layer SPL including a polymer film may be provided. A surface of the support layer SPL may be modified. Modifying a surface PS may include, for example, performing plasma treatment or acid treatment. The plasma treatment may include, for example, oxygen gas and argon gas.

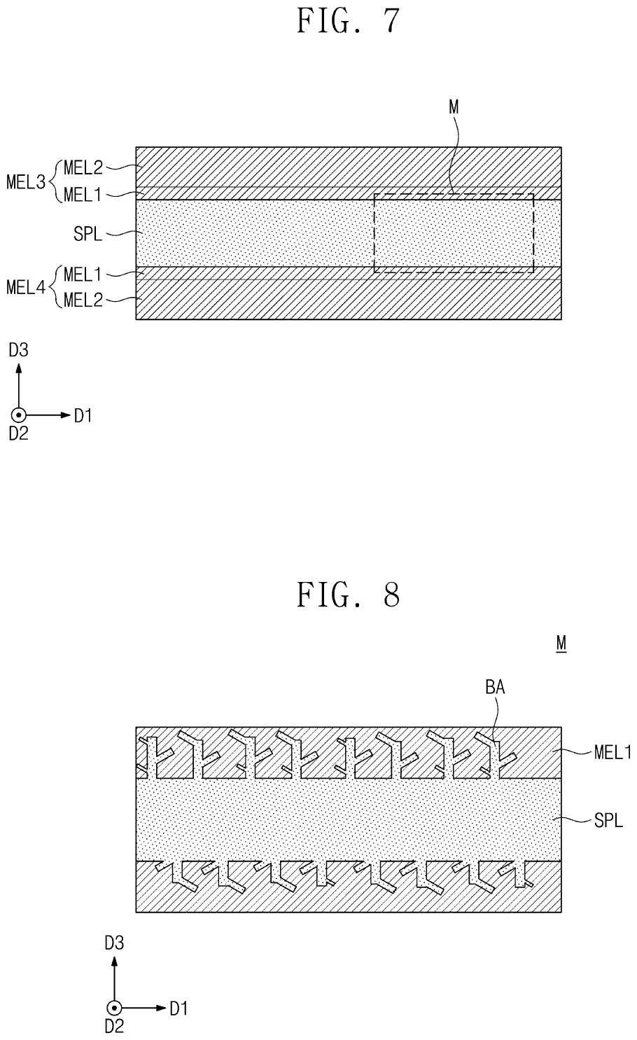

Referring to FIG. 10, the modified surface of the support layer SPL may include a plurality of bonding portions BA of the support layer SPL. The plurality of bonding portions BA may each have an irregular shape and a three-dimensional structure. The plurality of bonding portions BA may be formed through physical stimulation of plasma or through chemical stimulation by acid treatment.

The plurality of bonding portions BA may each include a functional group including oxygen on the surface thereof. The functional group including oxygen may include, for example, at least one of —O²⁻, —OH, and —COOH.

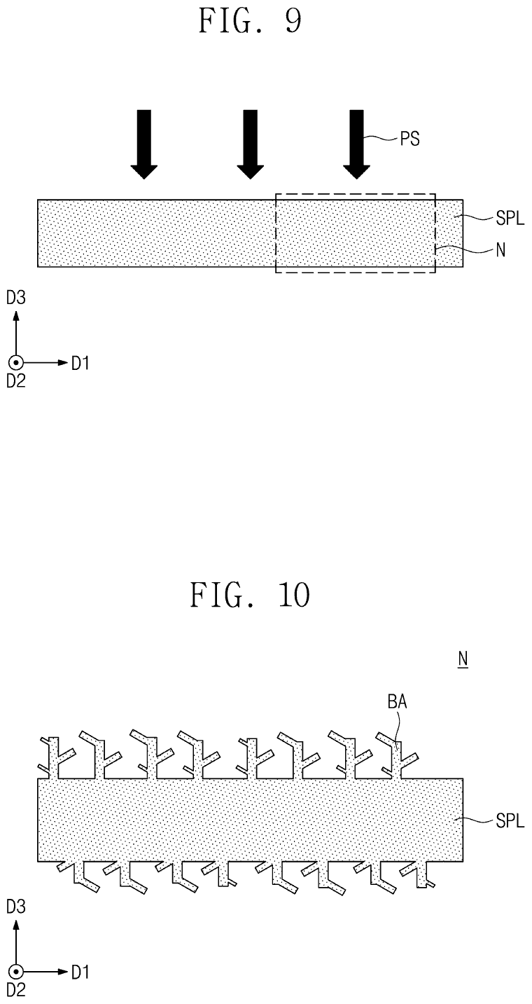

Referring to FIG. 11, a first compound C1 including a glycidyl group may be bonded (e.g., chemically bonded) to the modified surface of the support layer SPL. An end other than an epoxy functional group of the first compound C1 may be chemically bonded to the modified surface of the support layer SPL. The first compound C1 may be chemically bonded to a functional group including oxygen of each of the plurality of bonding portions. For example, the first compound C1 may be chemically bonded to any one of —O²—, —OH, and —COOH. The first compound C1 may be or include, for example, at least one of glycidyl methacrylate, glycidyl methyl ether, poly glycidyl methacrylate, or a combination thereof.

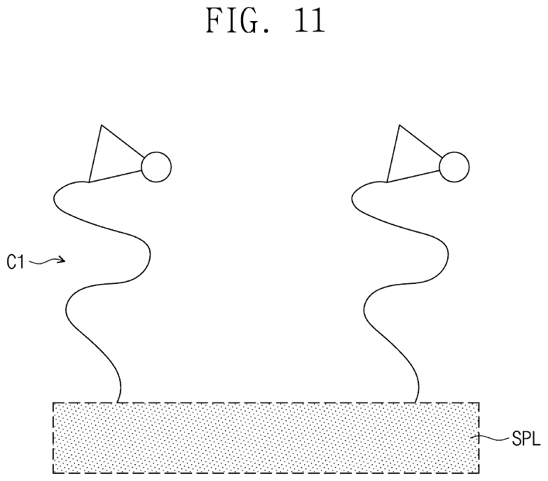

Referring to FIG. 12, an adhesion enhancer AE may be formed on the surface of the support layer SPL. A second compound including an amine group may be bonded to an epoxy functional group of the first compound to form the adhesion enhancer AE. For example, the second compound may be or include diethylenetriamine (DETA). The adhesion enhancer AE may be formed through Reaction Formula 1 below.

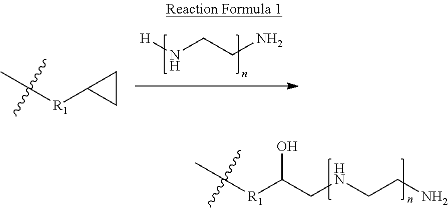

The radical R1 is or includes any one of C₁ to C₁₀ alkylene groups, and “n” may be an integer in a range of 0 and 10.

The forming of the adhesion enhancer AE may be performed at a temperature in a range of about 60° C. to about 80° C. That is, Reaction Formula 1 above may be performed at a temperature in a range of about 60° C. to about 80° C. A wavy line shown in Reaction Formula 1 above may indicate a portion chemically bonded to a functional group on the surface of the support layer SPL or a polymer on the surface of the support layer SPL.

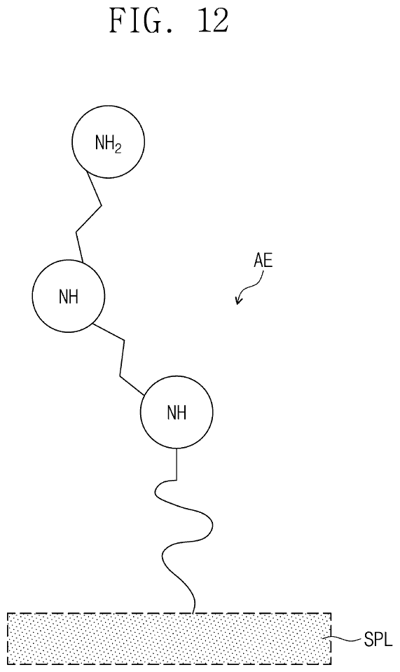

Referring to FIGS. 13, 14, and 15, the support layer SPL may be impregnated with a first solution SL1 that includes first copper ions. The first copper ions may be adsorbed onto the adhesion enhancer AE. The first solution SL1 may include a first metal salt including a first copper ion Cu1 and a catalyst. The first metal salt may be or include, for example, at least one of CuSO₄ and CuCl₂. The metal salt in the first solution SL1 may be present, for example, at a concentration in a range of about 0.12 M to about 0.25 M. The catalyst may be or include, for example, at least one of palladium (Pd) and platinum (Pt). The first solution may have a pH in a range of about 3 to about 5. When the pH of the first solution satisfies the numerical range described above, the first copper ion adsorbed onto the adhesion enhancer AE may increase in amount and may be substantially uniformly adsorbed.

The first copper ion Cu1 may be stabilized by the second moiety of the adhesion enhancer AE. The first copper ion Cu1 may be stabilized by amine groups of the second moiety (e.g., —NH— or —NH2). For example, the first copper ion Cu1 may be stabilized by amine groups having a free electron pair that may be bonded to the first copper ion Cu1. For example, the first copper ion Cu1 may be stabilized by chelate formation through coordination bonding with an amine group.

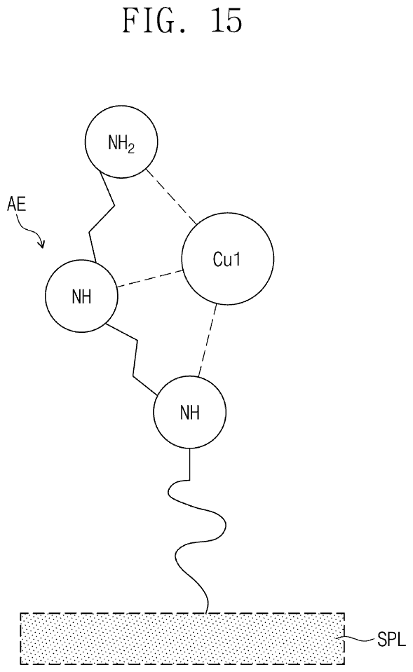

Referring to FIGS. 13 and 16, a first metal layer MEL1 may be formed. Forming the first metal layer MEL1 may include impregnating the support layer SPL with a second solution SL2 that includes a reducing agent.

The reducing agent may include, for example, at least one of formaldehyde, glucose, sodium hypophosphate, and a boron compound. The second solution SL2 may further include a complexing agent, a stabilizer, and a pH regulator. The complexing agent may include, for example, ethylenediaminetetraacetic acid (EDTA). The stabilizer may include, for example, at least one of triethanolamine (TEA) or 2,2′-bipridine. The pH regulator may include, for example, NaOH. The second solution SL2 may have, for example, a pH in a range of about 11 to about 13. When the pH of the second solution SL2 satisfies the numerical range described above, the first metal layer MEL1 may be substantially uniformly formed on the surface of the support layer SPL.

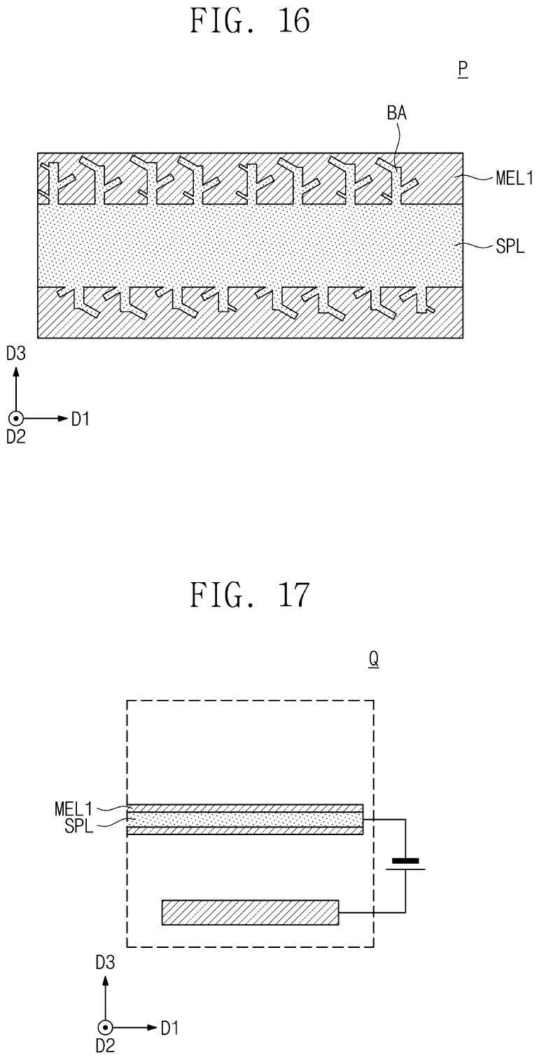

Referring to FIGS. 13 and 17, the second metal layer MEL2 may be formed on the first metal layer MEL1. Forming the second metal layer MEL2 may include impregnating the support layer SPL and the first metal layer MEL1 on the support layer SPL with a third solution SL3 that includes second copper ions.

Referring to FIG. 17, the forming of the second metal layer MEL2 may be performed, for example, through a water electroplating process. The support layer SPL and the first metal layer MEL1 on the support layer SPL may be connected to a negative electrode, and a copper electrode including second copper ions may be included as a positive electrode. In this case, a constant voltage in a range of about 5 V to about 15 V may be applied.

The third solution SL3 may further include an electrolyte, a complexing agent, and a pH regulator. The electrolyte may include, for example, at least one of copper sulfate (CuSO₄), sulfuric acid (H₂SO₄), hydrochloric acid (HCl), copper chloride (CuCl₂), and acetic acid (C₂H₄O₂). The complexing agent may include, for example, EDTA. The pH regulator may include, for example, at least one of hydrochloric acid, acetic acid, sulfuric acid, and citric acid. The third solution SL3 may have, for example, a pH in a range of about 0.5 to about 2.5. When the pH of the third solution SL3 satisfies the numerical range described above, the second metal layer MEL2 may be substantially uniformly formed on the first metal layer MEL1.

The first metal layer MEL1 and the second metal layer MEL2 may include the same metal (e.g., copper), and accordingly, the second metal layer MEL2 may be stably formed on the first metal layer MEL1.

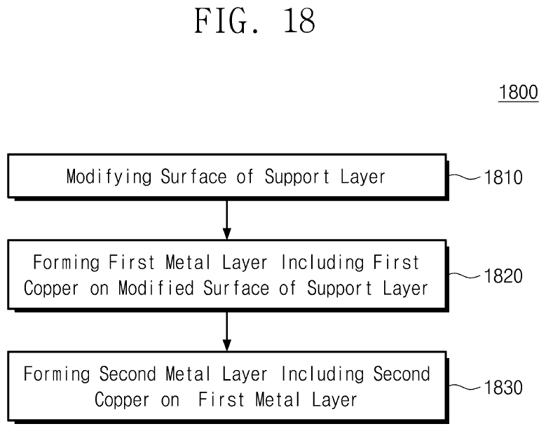

FIG. 18 is a flow chart illustrating a method for preparing a composite substrate for a rechargeable lithium battery, according to an example embodiment. In FIG. 18, the method 1800 includes operation 1810 which includes modifying a surface of a support layer. For example, modifying the surface of the support layer includes performing at least one of plasma treatment and acid treatment. In another example, the modified surface of the support layer includes at least one of —O²⁻, —OH, and —COOH. In an example, the support layer includes a polymer film, and the polymer film includes at least one of a polyethylene film, a polypropylene film, a polyvinylidene chloride film, and a multilayer film including a combination thereof.

Operation 1820 includes forming a first metal layer including a first copper on the modified surface of the support layer. For example, the forming of the first metal layer includes bonding a first compound including a glycidyl group to the modified surface of the support layer, bonding a second compound including an amine group to an end of the first compound to form an adhesion enhancer, impregnating the support layer with a first solution including first copper ions, and impregnating the support layer with a second solution including a reducing agent to reduce the first copper ions. In an example, the first solution has a pH in a range of about 3 to about 5. For example, the reducing agent of the second solution includes at least one of formaldehyde, glucose, sodium hypophosphate, and boron compounds. In another example, forming the adhesion enhancer is performed at a temperature in a range of about 60° C. to about 80° C.

In an example, the adhesion enhancer includes a compound of Formula 1:

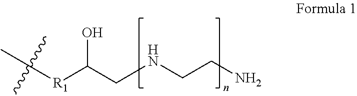

wherein R1 includes one of C₁ to C₁₀ alkylene groups, and n is a natural number that is equal to or greater than 1. In an example, n is equal to 2.

Operation 1830 includes forming a second metal layer including a second copper on the first metal layer. In an example, forming the second metal layer includes impregnating the support layer and the first metal layer on the support layer with a third solution including second copper ions. For example, the third solution further includes an electrolyte, a complexing agent, and a pH regulator, and the electrolyte includes at least one of copper sulfate (CuSO₄), sulfuric acid (H₂SO₄), hydrochloric acid (HCl), copper chloride (CuCl₂), and acetic acid (C₂H₄O₂).

The present invention is described below through Examples and Comparative Examples.

### Example 1

A 2 μm thick polypropylene film was prepared as a support layer. A surface of the support layer was treated with oxygen plasma and argon plasma. The plasma-treated support layer was impregnated with a solution including 0.1 M glycidyl methacrylate and using ethanol as a solvent. The support layer was impregnated with a solution including 0.2 M diethylenetriamine and using water as a solvent, and then heated to 80° C. to form an adhesion enhancer on the support layer.

Thereafter, the support layer was impregnated with a first solution including 0.12 M CuSO₄ and palladium (Pd). Then, the support layer was impregnated with a second solution including formaldehyde, EDTA, TEA, and NaOH to form a first metal layer. 0.1 M formaldehyde, 0.01 M EDTA, 0.02 M TEA, and 0.2 M NaOH were mixed to prepare a second solution. The second solution had a pH of 11. The first metal layer had a thickness of 3 nm.

The first metal layer and the support layer were impregnated with a third solution. 0.12 M CuSO₄, 0.01 M EDTA, and 0.15 M acetic acid were mixed to prepare a third solution. A negative electrode was connected to a positive electrode made of copper metal on the first metal layer and the support layer, and a constant voltage of 6 V was applied. Subsequently, a second metal layer was formed on the first metal layer. The first metal layer and the second metal layer has a total thickness of 12 μm.

### Example 2

A composite substrate was prepared in the same manner as in Example 1, with a difference that a polyethylene film was used as the support layer.

### Comparative Example 1

A 2 μm thick polypropylene film was prepared as a support layer. The support layer was deposited with a first metal layer made of a nickel-chromium alloy through a sputtering process. The nickel-chromium alloy had a thickness of 13 μm. Thereafter, a second metal layer was formed in the same manner as in Example.

### Comparative Example 2

A 2 μm thick polyethylene film was prepared as a support layer. The support layer was deposited with a first metal layer made of a nickel-chromium alloy through a sputtering process. The nickel-chromium alloy had a thickness of 13 μm. Thereafter, a second metal layer was formed in the same manner as in Example.

### Evaluation Example

The support layer was fixed, and the first metal layer was pulled at an angle of 90°, and adhesive strength was measured in accordance with the standard of ASTM D6862. The results of the adhesive strength evaluation are shown in Table 1 below.

TABLE 1

| | Adhesive strength (N/m) |
|---|---|
| Example 1 | 900 |
| Example 2 | 1130 |
| Comparative Example 1 | 650 |
| Comparative Example 2 | 1000 |

Referring to Table 1, it is determined that Example 1 exhibits greater adhesive strength than Comparative Example 1. Similarly, it is determined that Example 2 exhibits greater adhesive strength than Comparative Example 2. Accordingly, the composite substrate according to example embodiments of the present invention has greater stability.

According to example embodiments of the present invention, a composite substrate may include a support layer and a metal layer.

The metal layer may include a first metal layer including an adhesion enhancer.

The adhesion enhancer may include a first portion including a hydroxyalkylene group, and a second portion including an amine group configured to adsorb a first copper.

The support layer and the first metal layer may be stably bonded through the first portion, and copper ions may be stably adsorbed onto the support layer through the second portion.

The support layer and the metal layer may provide a desired or improved adhesive strength through the first portion and the second portion.

Furthermore, a rechargeable lithium battery exhibiting a desired or improved stability, including the composite substrate, may be provided.

Although the example embodiments of the present invention have been described above with reference to the accompanying drawings, the present invention may be applied in other specific forms without changing the technical idea or essential features thereof. Therefore, the above-described example embodiments are to be considered in all aspects as illustrative and not restrictive.

What is claimed is:

1. A composite substrate for a rechargeable lithium battery, the composite substrate comprising:
a support layer comprising a polymer film; and
a metal layer on the support layer and comprising at least one of copper and copper oxide,
wherein the metal layer comprises:
a first metal layer on a surface of the support layer and comprising an adhesion enhancer and a first copper; and
a second metal layer on the first metal layer and comprising a second copper, and
the adhesion enhancer comprises:
a first moiety chemically bonded to the surface of the support layer and comprising a hydroxyalkylene group; and
a second moiety comprising an amine group configured to adsorb the first copper.

2. The composite substrate for a rechargeable lithium battery of claim 1, wherein the adhesion enhancer comprises a compound of Formula 1 below: 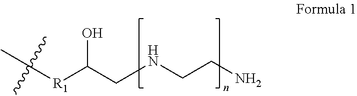
R1 comprises one of direct bonding or a C₁ to C₁₀ alkylene group, and
n is an integer in a range of 0 to 10.

3. The composite substrate for a rechargeable lithium battery of claim 2, wherein n is equal to 2.

4. The composite substrate for a rechargeable lithium battery of claim 1, wherein a bonding strength between the metal layer and the support layer is in a range of about 700 N/m to about 1200 N/m.

5. The composite substrate for a rechargeable lithium battery of claim 1, wherein the first metal layer has a thickness in a range of about 2 nm to about 5 nm.

6. The composite substrate for a rechargeable lithium battery of claim 1, further comprising a negative electrode coating layer on the metal layer, wherein the negative electrode coating layer comprises a negative electrode active material, a binder, and a conductive material.

7. The composite substrate for a rechargeable lithium battery of claim 1, wherein the polymer film comprises at least one of a polyethylene film, a polypropylene film, a polyvinylidene chloride film, and a multilayer film including a combination thereof.

8. The composite substrate for a rechargeable lithium battery of claim 1, wherein the support layer has a thickness in a range of about 2 μm to about 10 μm.

9. A method for preparing a composite substrate for a rechargeable lithium battery, the method comprising:
modifying a surface of a support layer;
forming a first metal layer comprising a first copper on the modified surface of the support layer; and
forming a second metal layer comprising a second copper on the first metal layer,
wherein the forming of the first metal layer comprises:
bonding a first compound comprising a glycidyl group to the modified surface of the support layer;
bonding a second compound comprising an amine group to an end of the first compound to form an adhesion enhancer;
impregnating the support layer with a first solution comprising first copper ions; and
impregnating the support layer with a second solution comprising a reducing agent to reduce the first copper ions.

10. The method of claim 9, wherein the modifying of the surface of the support layer comprises performing at least one of plasma treatment and acid treatment.

11. The method of claim 9, wherein the modified surface of the support layer comprises at least one of —O²⁻, —OH, and —COOH.

12. The method of claim 9, wherein the adhesion enhancer comprises a compound of Formula 1: 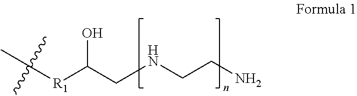
wherein R1 comprises one of C₁ to C₁₀ alkylene groups, and
n is a natural number that is equal to or greater than 1.

13. The method of claim 12, wherein n is equal to 2.

14. The method of claim 9, wherein the reducing agent of the second solution comprises at least one of formaldehyde, glucose, sodium hypophosphate, and boron compounds.

15. The method of claim 9,
wherein the forming of the second metal layer comprises impregnating the support layer and the first metal layer on the support layer with a third solution comprising second copper ions.

16. The method of claim 15, wherein the third solution further comprises an electrolyte, a complexing agent, and a pH regulator, and
the electrolyte comprises at least one of copper sulfate (CuSO₄), sulfuric acid (H₂SO₄), hydrochloric acid (HCl), copper chloride (CuCl₂), and acetic acid (C₂H₄O₂).

17. The method of claim 9, wherein the first solution has a pH in a range of about 3 to about 5.

18. The method of claim 9, wherein the forming of the adhesion enhancer is performed at a temperature in a range of about 60° C. to about 80° C.

19. The method of claim 9, wherein the support layer comprises a polymer film, and
the polymer film comprises at least one of a polyethylene film, a polypropylene film, a polyvinylidene chloride film, and a multilayer film including a combination thereof.

20. A rechargeable lithium battery comprising:
the composite substrate of claim 1; and
a battery cell on the composite substrate,
wherein the battery cell comprises:
a first active material layer on the metal layer;
a separator on the first active material layer;
a second active material layer on the separator; and
a metal substrate on the second active material layer.
